(19) United States
(12) Patent Application Publication
(10) Pub. No.: US 2012/0138599 A1
(43) Pub. Date: Jun. 7, 2012

(54) SEMICONDUCTOR SUBSTRATE HEAT TREATMENT APPARATUS

(75) Inventors: Junya Miyata, Tamano-shi (JP); Naoki Uchida, Tamano-shi (JP)

(73) Assignee: MITSUI ENGINEERING & SHIPBUILDING CO., LTD., Tokyo (JP)

(21) Appl. No.: 13/383,722

(22) PCT Filed: Sep. 30, 2010
(86) PCT No.: PCT/JP2010/067103

§ 371 Date: Jan. 12, 2012

(30) Foreign Application Priority Data
Jul. 20, 2010 (JP) 2010-162609

(51) Int. Cl. H05B 6/10

(52) U.S. Cl. 219/634

(57) ABSTRACT

A semiconductor substrate heat treatment apparatus includes a boat formed by stacking, in a vertical direction, a plurality of susceptors to be treated placing wafers thereon individually, and auxiliary susceptors disposed in a manner to sandwich the plurality of susceptors to be treated therebetween in the vertical direction; an induction heating coil disposed on an outer circumferential side of the boat and configured to generate an alternating magnetic flux in a direction parallel to planes of the plurality of susceptors to be treated on which the wafers are individually placed; and a power supply configured to supply power to the induction heating coil.

### TECHNICAL FIELD

The present invention relates to a semiconductor substrate heat treatment apparatus, and particularly relates to a semiconductor substrate heat treatment apparatus suitable for controlling a temperature of an object to be heated when a substrate such as a wafer having a large diameter is thermally processed.

### BACKGROUND ART

As an apparatus for performing heat treatment using induction heating on a substrate such as a semiconductor wafer, what is disclosed in Patent Document 1 or Patent Document 2 is known. As illustrated in FIG. 5, a heat treatment apparatus disclosed in Patent Document 1 is a batch-type heat treatment apparatus in which wafers 2 stacked in a plurality of layers are placed in a process tube 3 made of quartz; a heating tower 4 formed of a conductive member such as graphite is placed in an outer circumference of the process tube 3; and an induction heating coil 5 in a solenoid shape is arranged on an outer circumference thereof. According to the heat treatment apparatus 1 structured in this way, the heating tower 4 is heated by an influence of a magnetic flux generated by the induction heating coil 5, and the wafer 2 placed inside the process tube 3 is heated by heat of radiation from the heating tower 4.

As illustrated in FIG. 6, a heat treatment apparatus disclosed in Patent Document 2 is a single-wafer type heat treatment apparatus in which susceptors 7 concentrically hyperfractionated are formed of graphite or the like; a wafer 8 is placed on an upper side of the susceptors 7; a plurality of induction heating coils 9 in an annular shape are placed concentrically on a lower side of the susceptors 7; and power of the plurality of induction heating coils 9 can be individually controlled. According to the heat treatment apparatus 6 structured in this way, heat conduction between the susceptor 7 placed in a position within a heating range of each of the induction heating coils 9 and other susceptors 7 is restricted, and, as a result, a temperature distribution controllability of the wafer 8 by power control on the induction heating coils 9 is improved.

Whereas Patent Document 2 discloses that the heat distribution is well controlled by dividing the susceptor 7 on which the wafer 8 is placed, Patent Document 3 discloses that the heat distribution is improved by devising a cross sectional shape of a susceptor. In a heat treatment apparatus disclosed in Patent Document 3, a thickness of the susceptor at an inner portion is made thicker so that a distance of the inner portion from the induction heating coil becomes closer than that of an outer portion, and an increase in the amount of heat generation and an increase in the heat capacity are achieved by focusing attention on the fact that an amount of heat generation becomes smaller in an inner side where a diameter of an induction heating coil formed in an annular shape is smaller.

### PRIOR ART DOCUMENT

### Patent Documents

### [Patent Document 1]

Japanese Patent Application Laid-Open No. 2004-71596

### [Patent Document 2]

Japanese Patent Application Laid-Open No. 2009-87703

### [Patent Document 3]

Japanese Patent Application Laid-Open No. 2006-100067

### DISCLOSURE OF THE INVENTION

### Problem to be Solved by the Invention

However, according to any of the heat treatment apparatuses structured as described above, a magnetic flux is exerted vertically to the graphite. For this reason, in the case where a metallic film or the like is formed on a surface of the wafer subjected to heating, the wafer may be directly heated, which causes disturbance in the temperature distribution control.

In contrast, it may be considered possible to restrict the direct heating of the wafer if heating is facilitated by providing the magnetic flux in a horizontal direction with respect to the graphite (susceptor). In that case, however, it is difficult to control the temperature distribution in a horizontal plane. Further, since such heat treatment apparatuses using the induction heating are arranged as a cold-wall type, a problem is caused in that a decrease in temperature by heat radiation in an upper portion and a lower portion serving as end portions of the heated portion becomes conspicuous.

In view of this, it is an object of the present invention to provide a semiconductor substrate heat treatment apparatus that can solve the foregoing problem, apply a horizontal magnetic flux to a susceptor, and suppress a treatment failure caused by heat radiation at upper and lower end portions when a batch process is performed.

### Means for Solving the Problem

To achieve the object, the semiconductor substrate heat treatment apparatus includes a boat formed by stacking, in a vertical direction, a plurality of susceptors to be treated placing objects to be heated thereon individually, and auxiliary susceptors disposed in a manner to sandwich the plurality of susceptors to be treated therebetween in the vertical direction; an induction heating coil disposed on an outer circumferential side of the boat and configured to generate an alternating magnetic flux in a direction parallel to planes of the plurality of susceptors to be treated on which the objects to be heated are individually placed; and a power supply configured to supply power to the induction heating coil. The induction heating coil includes a main heating coil whose share to heat the plurality of susceptors to be treated is high, and an auxiliary heating coil whose share to heat the auxiliary susceptors is high while being disposed in close proximity to the main heating coil, and the power supply includes a zone control unit configured to control a proportion of power to be supplied to the main heating coil and the auxiliary heating coil.

In the semiconductor substrate heat treatment apparatus with the foregoing feature, each of the main heating coil and the auxiliary heating coil includes a coil winding region whose cross section may be rectangular, and a length in the vertical direction in the winding region of the main heating coil may be longer than a length in the vertical direction in the winding region of the auxiliary heating coil.

With this feature, it is possible to increase the stacking region of the susceptors to be treated. Accordingly, the number of the susceptors to be treated can be increased as compared with that of the auxiliary susceptors. This makes it possible to increase the treatment efficiency and reduce the cost.

In the semiconductor substrate heat treatment apparatus with the foregoing feature, it is preferable that two or more of the auxiliary susceptors be each disposed above and below a group of the plurality of susceptors to be treated.

With this feature, the auxiliary susceptor disposed at the endmost portions (uppermost and lowermost portions) suppress heat radiation, and the auxiliary susceptor disposed inside therefrom facilitate heating. Accordingly, the temperature distribution in a stacking direction of the susceptors to be treated that are sandwiched by the auxiliary susceptors can be stabilized.

Further, in the semiconductor substrate heat treatment apparatus with the foregoing feature, it is preferable that a core formed of a conductive member be disposed inside each of the main heating coil and the auxiliary heating coil that are wound.

With this feature, it is possible to prevent the magnetic flux from spreading as compared with the case where the heating coils are formed of a coil base material alone. Accordingly, it is possible to improve the heating efficiency.

### Advantage of the Invention

According to the semiconductor substrate heat treatment apparatus having the foregoing feature, it is possible to apply a horizontal magnetic flux to the susceptors and suppress the treatment failure caused by the heat radiation from the upper and lower ends during a batch process.

### BRIEF DESCRIPTION OF THE DRAWINGS

FIGS. 1A and 1B are diagrams illustrating a structure of a heat treatment apparatus according to a first embodiment of the present invention; FIG. 1A is a partial cross sectional block diagram illustrating a structure in side view; and FIG. 1B is a block diagram illustrating a structure in plan view.

FIG. 2 is a partial cross sectional block diagram illustrating a structure in side view of a heat treatment apparatus according to a second embodiment of the present invention.

FIG. 3 is a block diagram illustrating a structure in plan view of a heat treatment apparatus according to a third embodiment of the present invention.

FIG. 4 is a diagram illustrating an aspect in which a main heating coil is divided into a plurality of pieces to cope with an increase of susceptors to be treated.

FIG. 5 is a diagram illustrating a structure of a conventional batch-type induction heating apparatus.

FIG. 6 is a diagram illustrating a structure of a conventional single-wafer type induction heating apparatus.

### BEST MODE FOR CARRYING OUT THE INVENTION

### First Embodiment

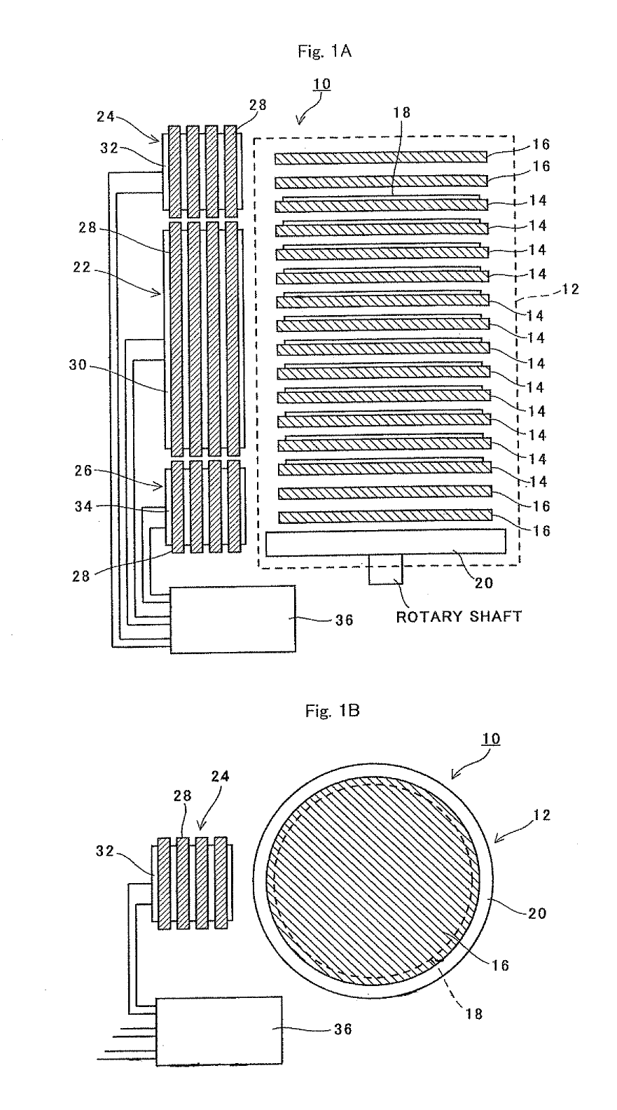

Hereinafter, embodiments of a semiconductor substrate heat treatment apparatus according to the present invention will be described in detail with reference to the drawings. First, referring to FIG. 1, a schematic structure of the semiconductor substrate heat treatment apparatus (hereinafter, simply referred to as “heat treatment apparatus”) according to a first embodiment will be described. FIG. 1A is a partial cross sectional block diagram illustrating a structure in side view of the heat treatment apparatus, and FIG. 1B is a block diagram illustrating a structure in top view of the heat treatment apparatus.

A heat treatment apparatus 10 according to this embodiment is a batch type for performing heat treatment by stacking, in a plurality of layers, wafers 18 as objects to be heated and susceptors as heating bodies.

The heat treatment apparatus 10 is basically structured of a boat 12, induction heating coils (a main heating coil 22, and auxiliary heating coils 24 and 26), and a power supply 36.

The boat 12 is basically structured of susceptors (hereinafter, referred to as “susceptors 14 to be treated”) on which wafers that are objects to be heated are placed, and susceptors (hereinafter, referred to as “auxiliary susceptors 16) that are placed above and below the susceptors 14 to be treated to suppress heat radiation and secure stability of temperature distribution in a vertical direction. To be specific, the structure includes stacking a plurality of the susceptors 14 to be treated in a vertical direction, and placing the auxiliary susceptors 16 individually above and below the stacked plurality of susceptors 14 to be treated. Supporting members (not illustrated) are placed individually between the stacked susceptors so that predetermined gaps are secured therebetween. Here, it is preferable to use, as the supporting members, quartz or the like that is not affected by magnetic flux, has a high thermal resistance, and has a small coefficient of thermal expansion.

It is preferable to place at least two of the auxiliary susceptors 16 each above and below the susceptors 14 to be treated that are stacked (a group of susceptors to be treated). With this arrangement, the auxiliary susceptor 16 placed at an endmost portion (the top or bottom portion) suppresses the heat radiation, and the auxiliary susceptor 16 placed inside next thereto facilitates heating. Accordingly, it is possible to maintain the uniformity of temperature in the susceptors 14 to be treated placed inside the auxiliary susceptors 16.

The susceptors 14 to be treated and the auxiliary susceptors 16 can be formed of an identical material and in an identical shape (disc shape in this embodiment). To be specific, they may be formed of a conductive member, and may be formed of, for example, graphite, SiC, SiC coated graphite, refractory metal, or the like.

The boat 12 structured in this way is placed on a rotary table 20 provided with a motor (not illustrated), and the susceptors (the susceptors 14 to be treated and the auxiliary susceptors 16) and the wafers 18 that are in the heat treatment process can be rotated. With this arrangement, it is possible to suppress a bias in heat generation distribution when the susceptors are heated. Accordingly, it is possible to uniformly heat the susceptors even in the case where the induction heating coils (the main heating coil 22, and auxiliary heating coils 24 and 26) arranged as described later are not evenly placed on an entire circumference of the susceptors, but are placed partially.

The induction heating coil according to this embodiment is formed by winding a coil base material 28 around the cores 30, 32, and 34 that are disposed on an outer circumferential side of the boat 12. The induction heating coil according to this embodiment is formed of the main heating coil 22 placed to heat the susceptors 14 to be treated as a main heating target, and the auxiliary heating coils 24 and 26 placed to heat the auxiliary susceptors 16 as a main heating target. To be specific, the main heating coil 22 has a winding region in a vertical direction so as to cover a region in which the stacked plurality of susceptors 14 to be treated are arranged. In contrast, each of the auxiliary heating coils 24 and 26 has a winding region in a vertical direction so as to cover a region in which the auxiliary susceptors 16 are arranged. Since the susceptors 14 to be treated are larger in number than the auxiliary susceptors 16, a length in a vertical direction in a winding region of the main heating coil 22 is larger than individual lengths in a vertical direction in winding regions of the auxiliary coils 24 and 26. The main coils 22 and the auxiliary coils 24 and 26 are arranged in such a way that a pair of the auxiliary heating coils 24 and 26 are respectively and closely disposed above and below the main heating coil 22 which serves as a center to cope with an arrangement layout of the susceptors 14 to be treated and the auxiliary susceptors 16. It is preferable that the coil base material 28 constituting each of the induction heating coils be a hollow tubular member (e.g., cupper tube). This makes it possible to allow a coolant (e.g., cooling water) to be inserted into the coil base material 28 during the heat treatment process and thereby suppress overheating of the induction heating coils themselves.

The cores 30, 32, and 34 may be formed of ferritic ceramic or the like, and a clay material may be formed into a shape and thereafter calcined. With use of such a material, it is possible to freely form a shape. Further, it is possible to prevent the magnetic flux from spreading and realize highly efficient induction heating in which the magnetic flux is concentrated by using the cores 30, 32, and 34 as compared with the case where the coil base material 28 alone forms the induction heating coils.

The main heating coil 22 and the auxiliary heating coils 24 and 26 are individually wound around the circumferences of the cores 30, 32, and 34 of which end faces are directed to a center of susceptors. As a result, a center axis along a winding direction of the coil base material 28 and a center axis of the wafers 18 or the susceptors while they are seated are directed to directions orthogonal to each other. As a result, the end faces of the cores 30, 32, and 34 facing the susceptors serve as magnetic pole faces, respectively. In this arrangement, alternating magnetic fluxes are generated in a direction parallel to surfaces of the susceptors on which the wafers are placed from the magnetic pole faces of the cores 30, 32, and 34 around which the coil base material 28 is wound.

The main heating coil 22 and two of the auxiliary heating coils 24 and 26 which are arranged as described above are connected to the single power supply 36. The power supply 36 is provided with a plurality of inverters (not illustrated) individually corresponding to the main heating coil 22 and the auxiliary heating coils 24 and 26, an AC power supply (not illustrated), a power control unit (not illustrated), and the like. Therefore, the power supply 36 is formed in such a manner that currents, voltages, frequencies, and the like to be supplied to the main heating coil 22 and the auxiliary heating coils 24 and 26 can be adjusted. Here, if a resonance-type is used as the inverter, it is preferable that resonance capacitors corresponding to individual control frequencies be connected in parallel and be capable of being switched over in accordance with a signal from the power control unit so that switching of the frequencies can be easily performed.

The power control unit according to this embodiment includes a zone control unit (not illustrated). The zone control unit plays a role of controlling supply power to the main heating coil 22 and the auxiliary heating coil 24 and 26 while avoiding an influence of mutual induction caused between the main heating coil 22 and the auxiliary heating coils 24 and 26.

The main heating coil 22 and the auxiliary heating coils 24 and 26 that are disposed in a stacked manner in close proximity to each other as described above are individually operated as individual induction heating coils. Accordingly, there may be a case where mutual induction is caused between the induction heating coils adjacent to each other in a vertical direction (for example, between the main heating coil 22 and the auxiliary heating coil 24, or between the main heating coil 22 and the auxiliary heating coil 26), and individual power controls are harmfully affected. For this reason, the zone control unit, based on the detected frequency of current or the waveform (waveform of current), performs control so that the frequencies of the currents to be supplied to the adjacently arranged induction heating coils coincide with each other and the phases of the waveforms of currents are synchronized with each other (making the phase difference zero or close to zero), or performs control so that the predetermined phase difference is maintained. In this way, power control (zone control) avoiding the influence of mutual induction between the induction heating coils arranged in close proximity to each other is made possible.

In this kind of control, amounts of currents, frequencies of currents, voltages, and the like supplied to the main heating coil 22 and the auxiliary heating coils 24 and 26 are detected and inputted to the zone control unit. The zone control unit detects, for example, phases of waveforms of currents of the main heating coil 22 and the auxiliary heating coil 24, and phases of waveforms of currents of the main heating coil 22 and the auxiliary heating coil 26, individually, and performs control so that these are synchronized or a phase difference therebetween is kept at a predetermined phase difference. This kind of control is performed by feeding out, to the power control unit, a signal that instantly changes the frequency of the current to be supplied to each of the induction heating coils.

In the case of the structure of the heat treatment apparatus 10 according to this embodiment and in the case of controlling power, it is a matter of outputting a signal for feeding out supply power that changes at elapsed time intervals since the start of heat treatment based on a control map (vertical temperature distribution control map) stored in an unillustrated storage portion (memory) provided in the power control unit. Here, the control map may be such a map that corrects temperature changes among the stacked susceptors between a period from the start of the heat treatment and the end of the heat treatment, and that records, with elapsed times since the start of the heat treatment, amounts of power to be fed to each of the induction heating coils to obtain an arbitrary temperature distribution (e.g., uniform temperature distribution).

According to the power supply 36 configured in this way, the frequencies of the currents to be supplied to the main heating coil 22 and the auxiliary heating coils 24 and 26 are instantly adjusted based on the signal from the power control unit, phase control of the waveforms of the currents is performed, and power control for each of the main heating coil 22 and the auxiliary heating coils 24 and 26 is performed, so that the temperature distribution in a vertical direction in the boat 12 can be controlled.

In addition, according to the heat treatment apparatus 10 structured as described above, the magnetic flux exerts horizontally with respect to the wafer 18, and therefore there is no possibility of a disturbance in the temperature distribution of the wafer 18 even in a case where a conductive member such as a metallic film is formed on a surface of the wafer 18.

Further, according to the heat treatment apparatus 10 structured as described above, the temperature distribution in a stacking direction of the susceptors 14 to be treated is stabilized because of the influence of the auxiliary susceptors 16. Accordingly, there is no possibility of a heat treatment failure caused in the wafer 18 placed on the susceptor 14 to be treated, and the yield in the wafer heat treatment is improved.

### Second Embodiment

Next, a second embodiment of the heat treatment apparatus according to the present invention will be described in detail with reference to the drawings. Most of the structure of the heat treatment apparatus according to this embodiment is same as that of the heat treatment apparatus 10 according to the foregoing first embodiment. Accordingly, portions whose structures are identical with those in the first embodiment will be allocated with numerals with an addition of 100 in the drawing, and detailed descriptions thereof will not be repeated here. The difference from the heat treatment apparatus 10 according to the first embodiment is that the heat treatment apparatus according to this embodiment is provided with a temperature detection unit 140.

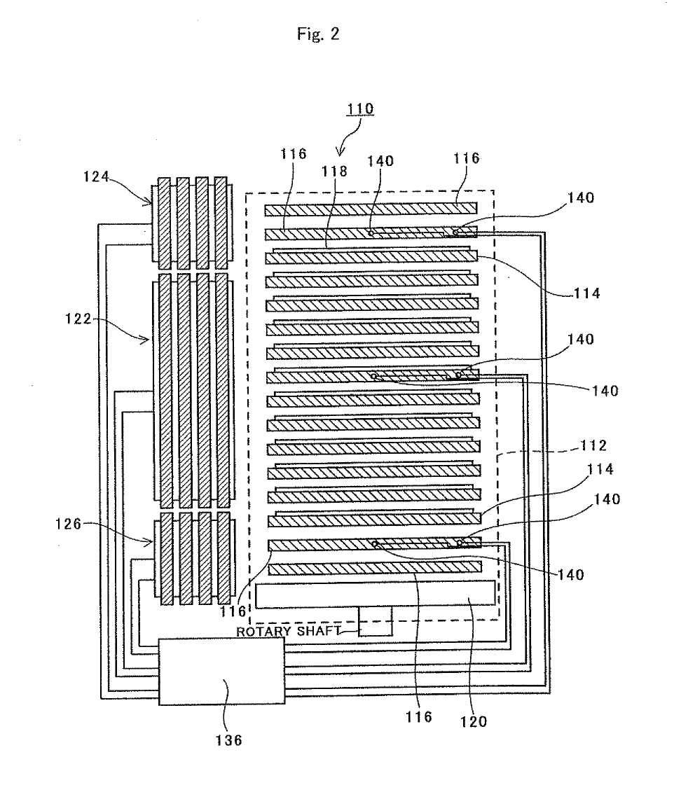

Although the temperature detection unit 140 may be of a radiation type, it is better to use a contact type such as a thermocouple type which is disposed to the susceptor as illustrated in FIG. 2. This is because the temperature detection unit 140 of the contact type can minimize a detection error which is caused by an external disturbance as compared with the temperature detection unit of the radiation type.

In the example illustrated in FIG. 2, the temperature detection unit 140 is provided to one of the susceptors constituting a group of the auxiliary susceptors 116, a group of the susceptors 114 to be treated, and a group of the auxiliary susceptors 116. To be specific, among a group of the susceptors constituted by the susceptors 114 to be treated, the temperature detection unit 140 is provided to the susceptor 114 to be treated placed in a substantially center in a stacking direction thereof. The susceptor 114 to be treated disposed in the center has the highest heating efficiency and is less susceptible to the influence of radiational cooling. Therefore, among the stacked susceptors 114 to be treated, the actual situation is that it is difficult to predict a decrease in temperature caused from the center to both ends (in vertical direction). Among the groups of the auxiliary susceptors 116, those that are individually adjacent to the susceptors 114 to be treated are provided with the temperature detection units 140, respectively. The reason is that, by maintaining the temperature of the auxiliary susceptor 116 placed next to the end of the susceptors 114 to be treated at a desired temperature, it is possible to predict that a similar temperature is secured in the susceptor 114 to be treated placed inside the auxiliary susceptor 116.

According to the embodiment, two of the temperature detection units 140 are provided to one susceptor. Specifically, the temperature detection units 140 are provided in two locations, i.e., in the center of the susceptor and on an outer circumferential side. Here, wiring of the temperature detection unit 140 is arranged so that rotation of the rotary table 120 is not disturbed by leading the wire using a supporting member, allowing the wire to pass through inside a shaft of the rotary table 120, and the like.

The temperature detection unit 140 is connected to the power supply 136 and feeds a detected temperature signal into the power control unit of the power supply 136. The power control unit calculates supply power for correcting the temperature distribution according to the detected temperature and controls supply power to the main heating coil 22 and the auxiliary heating coils 24 and 26.

According to this arrangement, it is possible to perform temperature control without creating a control map beforehand. Other structure, working, and effect are same as those of the heat treatment apparatus 10 according to the foregoing first embodiment.

### Third Embodiment

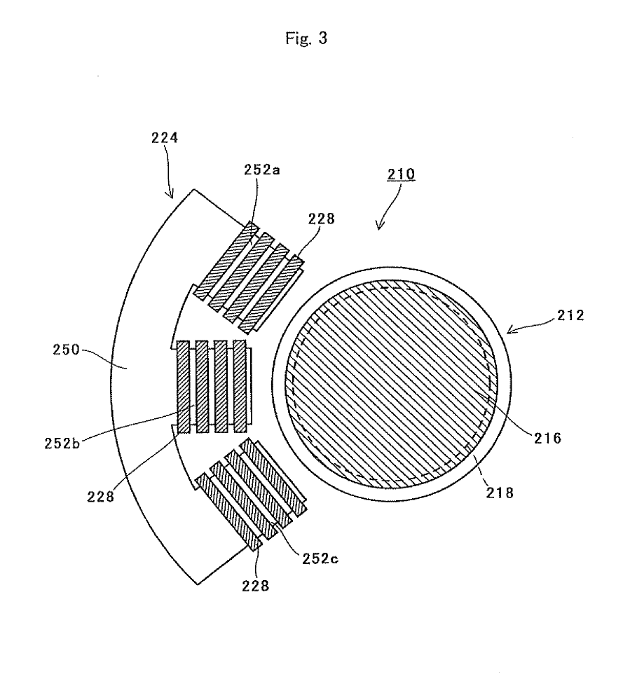

Next, a third embodiment of the heat treatment apparatus according to the present invention will be described with reference to FIG. 3. Most of the structure of the heat treatment apparatus according to this embodiment is same as those of the heat treatment apparatuses 10 and 110 according to the first and second embodiments. Accordingly, portions whose structures are identical with those in the foregoing will be allocated with numerals with an addition of 200 in the drawing, and detailed descriptions thereof will not be repeated here. The difference between the heat treatment apparatus 10 and 110 according to the first and second embodiments and the heat treatment apparatus according to this embodiment is found in the structure of the induction heating coil. To clarify this, FIG. 3 illustrates a structure in plan view of the heat treatment apparatus according to this embodiment.

A heat treatment apparatus 210 according to this embodiment is formed of three induction heating coils, i.e., an auxiliary heating coil 224, a main heating coil (not illustrated), and an auxiliary heating coil (not illustrated). Since the structures in plan view of the auxiliary heating coil 224, the main heating coil, and the auxiliary heating coil are substantially identical with each another, FIG. 3 illustrates only a structure of the auxiliary heating coil.

The auxiliary heating coil 224 is formed by individually winding a coil base material 228 around three protrusions (magnetic poles) 252a, 252b, and 252c that are provided in a single core 250. The winding directions of the coil base material 228 are as follows. For example, the winding direction of the coil base material 228 around the magnetic pole 252a serves as a reference direction, the winding directions around the magnetic poles 252b and 252c are opposite to the reference direction (so that the magnetic flux serves as an additive polarity). The coil base materials 228 wound around the magnetic poles 252a to 252c are connected in parallel to one another. The coil base material 228 wound around the magnetic pole 252a serves as a reference, and the coil base materials 228 wound around the magnetic poles 252b and 252c may be configured to be selected therebetween to decide whether to be operated or not.

With this arrangement, it is possible to change the reaching range of the magnetic flux with respect to the susceptors. As a result, it is possible to control the temperature distribution in a horizontal direction (and the in-plane temperature distribution as well) of the susceptors. In the case where this arrangement is adopted, it is better if an increase or decrease of the resonance capacitors in the power supply can also be switched along with the switching of the coil base material 228 to be operated. This is to organize a resonance circuit in a desired frequency band.

Other structure, working, and effect are same as those of the heat treatment apparatuses 10 and 110 according to the foregoing first embodiment.

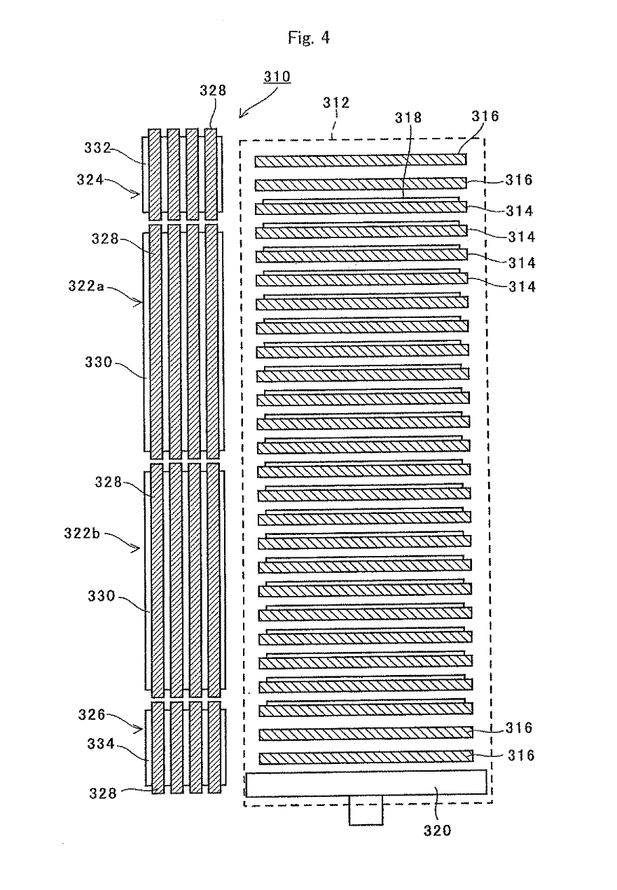

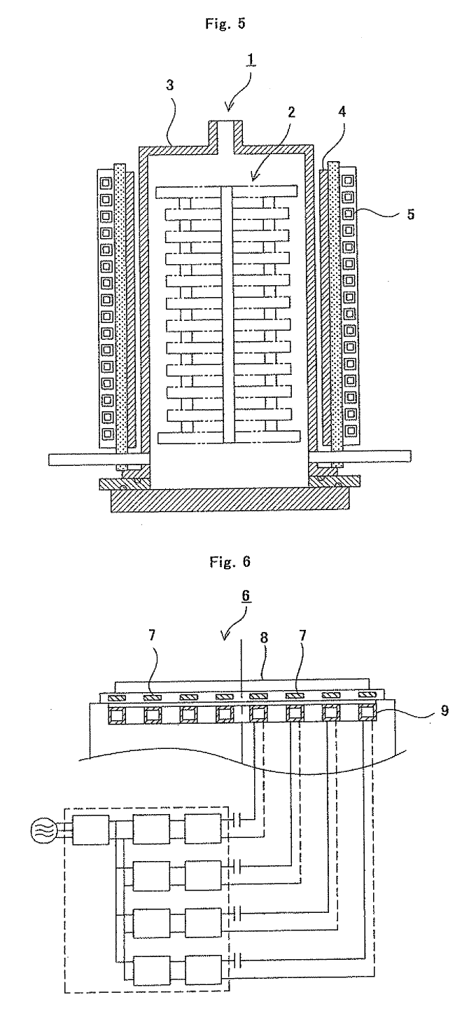

Further, the heat treatment apparatus according to the present invention may be arranged in a form illustrated in FIG. 4. In FIG. 4, portions having the same structure as those of the heat treatment apparatus according to the foregoing first embodiment are allocated with numerals with an addition of 300 in the drawing.

In any of the heat treatment apparatuses according to the foregoing embodiments, one piece for one group) of the main heating coil is provided, and one pair of auxiliary heating coils are provided so as to sandwich the main heating coil therebetween. However, according to this arrangement, if the number of the susceptors to be treated exceptionally increases, a bias may be caused in the temperature distribution in a vertical direction of the group of the susceptors to be treated. For this reason, in the case where the number of the susceptors 314 to be treated is increased, it is better to divide the main heating coil 322, and make an arrangement so that control of the supply power to the divided main heating coils 322a and 322b can be individually performed.

With this structure, it is possible to control the temperature distribution in a vertical direction of the susceptors 314 to be treated, and perform heating of the wafers 318 placed on the individual susceptors 314 to be treated accurately.

### DESCRIPTION OF REFERENCE NUMERALS

10: Semiconductor substrate heat treatment apparatus (heat treatment apparatus)
12: Boat
14: Susceptor to be treated
16: Auxiliary susceptor
18: Wafer
20: Rotary table
22: Main heating coil
24: Auxiliary heating coil
26: Auxiliary heating coil
28: Coil base material
30: Core
32: Core
34: Core
36: Power supply

1. A semiconductor substrate heat treatment apparatus comprising:
a boat formed by stacking, in a vertical direction, a plurality of susceptors to be treated placing objects to be heated thereon individually, and auxiliary susceptors disposed in a manner to sandwich the plurality of susceptors to be treated therebetween in the vertical direction, and the boat configured to be able to rotate the susceptors;
an induction heating coil disposed on an outer circumferential side of the boat, the induction heating coil being placed partially on an entire circumference of the susceptors and configured to generate an alternating magnetic flux in a direction parallel to planes of the plurality of susceptors to be treated on which the objects to be heated are individually placed;
and a power supply configured to supply power to the induction heating coil, wherein the induction heating coil includes a main heating coil whose share to heat the plurality of susceptors to be treated is high, and an auxiliary heating coil whose share to heat the auxiliary susceptors is high while being disposed in close proximity to the main heating coil, and the power supply includes a zone control unit configured to control a proportion of power to be supplied to the main heating coil and the auxiliary heating coil.

2. The semiconductor substrate heat treatment apparatus according to claim 1, wherein each of the main heating coil and the auxiliary heating coil includes a coil winding region whose cross section is rectangular, and a length in the vertical direction in the winding region of the main heating coil is longer than a length in the vertical direction in the winding region of the auxiliary heating coil.

3. The semiconductor substrate heat treatment apparatus according to claim 1, wherein at least two or more of the auxiliary susceptors are each disposed above and below a group of the plurality of susceptors to be treated.

4. The semiconductor substrate heat treatment apparatus according to claim 1, wherein a core formed of a conductive member is disposed inside the main heating coil and the auxiliary heating coil that are wound.

5. The semiconductor substrate heat treatment apparatus according to claim 2, wherein at least two or more of the auxiliary susceptors are each disposed above and below a group of the plurality of susceptors to be treated.

6. The semiconductor substrate heat treatment apparatus according to claim 2, wherein a core formed of a conductive member is disposed inside the main heating coil and the auxiliary heating coil that are wound.

7. The semiconductor substrate heat treatment apparatus according to claim 3, wherein a core formed of a conductive member is disposed inside the main heating coil and the auxiliary heating coil that are wound.

8. The semiconductor substrate heat treatment apparatus according to claim 5, wherein a core formed of a conductive member is disposed inside the main heating coil and the auxiliary heating coil that are wound.
